(19) United States
(12) Patent Application Publication
(10) Pub. No.: US 2007/0292306 A1
(43) Pub. Date: Dec. 20, 2007

(54) Method and System of Removing Moisture and Toxic Gas Components from Exhaust Gas

(76) Inventors: Yoshio Hirano, Hiroshima (JP); Kenji Hikino, Hiroshima (JP); Mitsugu Kakutani, Hiroshima (JP); Yoshio Seiki, Hiroshima (JP); Susumu Tsuneoka, Nagasaki (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/591,522

(22) PCT Filed: Mar. 2, 2005
(86) PCT No.: PCT/JP05/03450

§ 371 Date: Aug. 15, 2007

(30) Foreign Application Priority Data
Mar. 2, 2004 (JP) 2004-057605

(51) Int. Cl. B01D 53/78

(52) U.S. Cl. 422/38; 422/173

(57) ABSTRACT

A method of removing moisture and toxic gas components from exhaust gas, comprises making exhaust gas, exhausted from an LNG burning boiler, flow through coolant contained in a dehydrating tower to cool it to such a temperature as to solidify moisture and nitrogen oxides but not carbon dioxide, thereby solidifying moisture and nitrogen oxides contained in the exhaust gas to separate from the exhaust gas; introducing the solidified moisture and nitrogen oxides into a solid-liquid separator thereby separating the moisture or the nitrogen oxides from the coolant; and making the coolant be contained in a cooling tower so as to be cooled, and then making the coolant be contained in the dehydrating tower again so as to be circulated.

### TECHNICAL FIELD

The present invention relates to a method and system of removing moisture and toxic gas components from exhaust gas.

### BACKGROUND ART

Nitrogen oxides contained in exhaust gas exhausted from LNG burning boilers or the like -of generating stations, chemical plants, etc., are separated and removed with use of, for example, denitrification apparatuses using a denitrification catalyst. Further, a so-called physical absorption method using activated carbon is known as a more efficient method of separating and removing toxic gas components.

Meanwhile, in recent years, the amount of carbon dioxide in the atmosphere has increased, and thus a relationship with the increase in atmospheric temperature called the green house effect is becoming an issue. The increase in the amount of generated carbon dioxide is mostly caused by burning fossil fuel. Accordingly, generating stations, chemical plants, etc., are required to restrict the exhaust of carbon dioxide in exhaust gas into the atmosphere to be as little as possible from the environmental point of view. (Reference 1: Japanese Patent Application Laid-Open Publication No. 2000-317302.)

### DISCLOSURE OF THE INVENTION

### Problems to be Solved by the Invention

As such, as to the processing of exhaust gas exhausted from LNG burning boilers and the like, carbon dioxide needs to be retrieved efficiently while toxic gas components such as nitrogen oxides are removed efficiently. Thus, a scheme is needed which performs a sequence of the removal of toxic gas components and the retrieval of carbon dioxide efficiently and consecutively.

The present invention was made in view of the above background, and an object thereof is to provide a method and system of removing moisture and toxic gas components from exhaust gas, which can efficiently remove moisture and toxic gas components contained in exhaust gas exhausted from an LNG burning boiler or the like.

### Means for Solving the Problems

According to claim 1 of the invention, there is provided a method of removing moisture and toxic gas components from exhaust gas, comprising a process of making exhaust gas, exhausted from an LNG burning boiler, flow through coolant contained in a dehydrating tower to cool it to such a temperature as to solidify moisture and nitrogen oxides but not carbon dioxide, thereby solidifying moisture and nitrogen oxides contained in the exhaust gas to separate from the exhaust gas; a process of introducing the solidified moisture and nitrogen oxides into a solid-liquid separator thereby separating the moisture or the nitrogen oxides from the coolant; and a process of making the coolant be contained in a cooling tower so as to be cooled, and then making the coolant be contained in the dehydrating tower again so as to be circulated.

According to this invention, by making exhaust gas, exhausted from an LNG burning boiler, flow through coolant contained in a dehydrating tower to cool it to such a temperature as to solidify moisture and nitrogen oxides but not carbon dioxide, moisture and nitrogen oxides contained in the exhaust gas are solidified and separated from the exhaust gas. Therefore, the moisture and nitrogen oxides can be efficiently removed from the exhaust gas. Further, by introducing the solidified moisture and nitrogen oxides into a solid-liquid separator, the moisture or the nitrogen oxides is separated from the coolant. Therefore, the coolant can be efficiently retrieved. After introducing the coolant into a cooling tower so as to be cooled, the coolant is made to be contained in the dehydrating tower again so as to be circulated and used. Therefore, the coolant can be used effectively.

According to claim 2 of the invention, there is provided the method of removing moisture and toxic gas components from exhaust gas according to claim 1, comprising a process of introducing the moisture and nitrogen oxides separated from the coolant into a separation tower and raising in temperature the moisture and nitrogen oxides thereby liquefying the moisture and nitrogen oxides.

As such, by liquefying the moisture and nitrogen oxides separated from the coolant, the moisture and nitrogen oxides are improved in handleablility.

According to claim 3 of the invention, there is provided the method of removing moisture and toxic gas components from exhaust gas according to claim 2, comprising a process of introducing the coolant retrieved in the separation tower into the cooling tower.

As such, by retrieving the coolant in the separation tower as well, the coolant can be used effectively.

According to claim 4 of the invention, there is provided the method of removing moisture and toxic gas components from exhaust gas according to any one of claims 1 to 3, wherein the coolant includes any one of dimethyl ether, methanol, ethanol, toluene, and ethyl benzene.

The coolant is required to have the property of not solidifying at temperatures at which the toxic gas components are liquefied or solidified in order to separate the coolant from the toxic gas components liquefied or solidified in the first process. Further, to liquefy or solidify the toxic gas components efficiently with the coolant, the coolant is required to have the property of absorbing the toxic gas components easily. Yet further, to retrieve carbon dioxide from the exhaust gas efficiently in the second process, the coolant is required to have the property of hardly absorbing carbon dioxide. Any of the dimethyl ether, methanol, ethanol, toluene, and ethyl benzene meets this requirement.

According to claim 5 of the invention, there is provided the method of removing moisture and toxic gas components from exhaust gas according to any one of claims 1 to 4, comprising a process of cooling the coolant by using the heat of vaporization that is produced when LNG is used as gas fuel.

As such, by cooling by use of the heat of vaporization that is produced when LNG is used as gas fuel, energy for cooling can be saved.

According to claim 6 of the invention, there is provided a system of removing moisture and toxic gas components from exhaust gas, comprising an apparatus of making exhaust gas, exhausted from an LNG burning boiler, flow through coolant contained in a dehydrating tower to cool it to such a temperature as to solidify moisture and nitrogen oxides but not carbon dioxide, thereby solidifying moisture and nitrogen oxides contained in the exhaust gas to separate from the exhaust gas; an apparatus of introducing the solidified moisture and nitrogen oxides into a solid-liquid separator thereby separating the moisture or the nitrogen oxides from the coolant; and an apparatus of making the coolant be contained in a cooling tower so as to be cooled, and then making the coolant be contained in the dehydrating tower again so as to be circulated.

According to claim 7 of the invention, there is provided the system of removing moisture and toxic gas components from exhaust gas according to claim 6, comprising an apparatus of introducing the moisture and nitrogen oxides separated from the coolant into a separation tower and raising in temperature thereby liquefying the moisture and nitrogen oxides.

According to claim 8 of the invention, there is provided the system of removing moisture and toxic gas components from exhaust gas according to claim 7, comprising an apparatus of introducing the coolant retrieved in the separation tower into the cooling tower.

According to claim 9 of the invention, there is provided the system of removing moisture and toxic gas components from exhaust gas according to any one of claims 6 to 8, wherein the coolant includes any one of dimethyl ether, methanol, ethanol, toluene, and ethyl benzene.

According to claim 10 of the invention, there is provided the system of removing moisture and toxic gas components from exhaust gas according to any one of claims 6 to 9, comprising an apparatus of cooling the coolant by using the heat of vaporization that is produced when LNG is used as gas fuel.

### BRIEF DESCRIPTION OF THE DRAWINGS

FIG. 1 shows schematically the configuration of an exhaust gas processing system according to an embodiment of the present invention;

FIG. 2A shows results of measuring change in the concentration of sulfur dioxide in the model gas when model gas having sulfur dioxide in a concentration of 80 ppm is made to flow through DME according to the embodiment of the present invention;

FIG. 2B shows the configuration of an apparatus used in measuring the amounts of sulfur dioxide and nitrogen monoxide dissolving in coolant according to the embodiment of the present invention;

FIG. 2C shows the composition of the model exhaust gas according to the embodiment of the present invention;

FIG. 2D shows results of measuring the amounts of sulfur dioxide and nitrogen monoxide dissolving in coolant according to the embodiment of the present invention;

FIG. 2E shows the configuration of a dry ice sublimator 24 used in measuring the retrieval rate of carbon dioxide against the temperature of model gas according to the embodiment of the present invention;

FIG. 2F is a side view of the dry ice sublimator 24 as seen in the direction indicated by an arrow A in FIG. 2E according to the embodiment of the present invention; and

FIG. 2G shows results of measuring the retrieval rate of carbon dioxide against the temperature of model gas according to the embodiment of the present invention.

### EXPLANATION OF REFERENCE NUMERALS

10 Exhaust gas source, 11 Heat exchanger,
13 Condenser, 14 Effluent cistern,
17 Dehydrating tower, 18 DME cooling tower,
20 DME separation tower, 22 Solid-liquid separator,
23 Reversible heat exchanger, 24 Dry ice sublimator,
25 Cyclone, 26 Dry ice melting device,
27 Liquefied-carbonic acid storage, 44 Refrigerator/Heat exchanger,
50 Effluent processing apparatus, 51 Smokestack

### BEST MODE FOR CARRYING OUT THE INVENTION

A preferred embodiment of an exhaust gas processing system according to the present invention will be described in detail below with reference to the accompanying drawings.

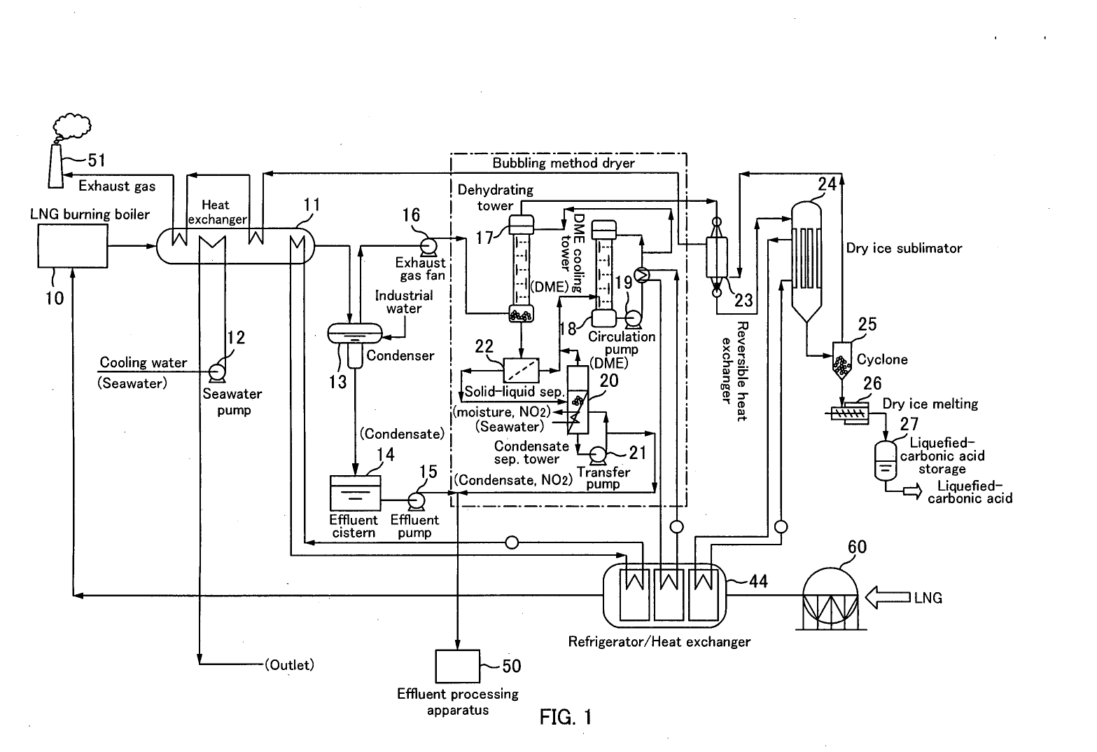

FIG. 1 shows the schematic configuration of an exhaust gas processing system according to the present embodiment. The exhaust gas processing system of the present embodiment provides a scheme that efficiently retrieves carbon dioxide contained in exhaust gas including toxic gas components such as nitrogen oxides, exhausted from an exhaust gas source 10 such as an LNG burning boiler of a generating station, chemical plant, etc., while efficiently removing moisture and toxic gas components contained in the exhaust gas.

In this exhaust gas processing system, in its preprocess, exhaust gas including toxic gas components such as nitrogen oxides, exhausted from the exhaust gas source 10 is introduced into industrial water contained in a heat exchanger 11 and a condenser 13 and thereby cooled to about room temperature. Then, in a first process, the exhaust gas cooled to about room temperature is cooled in a dehydrating tower 17 to such a first temperature as not to solidify carbon dioxide, and thereby moisture and nitrogen oxides contained in the exhaust gas are liquefied or solidified and thus separated from the exhaust gas. Next, in a second process, the exhaust gas has moisture and nitrogen oxides separated therefrom is cooled in a dry ice sublimator 24 to a second temperature lower than the first temperature, and thereby carbon dioxide contained in the exhaust gas is solidified and separated from the exhaust gas.

The toxic gas components separated in the first process are mixed with the coolant. The coolant is preferably circulated and used effectively in order to operate the exhaust gas processing system efficiently. Accordingly, in this embodiment, with use of the evaporation method using the difference in evaporation temperature between the coolant and the toxic gas components, the coolant is separated from the toxic gas components and retrieved, and the retrieved coolant is again used as coolant. Note that although the evaporation method needs energy for heating, the energy can be reduced by adopting a coolant having a low boiling point.

In order to retrieve carbon dioxide contained in the exhaust gas efficiently in the second process, the carbon dioxide needs to be not liquefied or solidified when moisture and the toxic gas components are liquefied or solidified. Carbon dioxide in exhaust gas from an LNG burning boiler solidifies into dry ice below a predetermined temperature. Hence, in order not to allow the carbon dioxide to solidify, gas temperature at the exit of the dehydrating tower 17 is made to be higher than the predetermined temperature.

In the first process, the coolant itself is required to have the property of not solidifying at temperatures at which the toxic gas components are liquefied or solidified in order to separate the coolant from the toxic gas components liquefied or solidified. Further, to liquefy or solidify the toxic gas components efficiently, the coolant is required to have the property of absorbing the toxic gas components easily. Yet further, to retrieve carbon dioxide from the exhaust gas efficiently in the second process, the coolant is required to have the property that carbon dioxide does not easily dissolve therein.

A specific coolant that satisfies these requirements is dimethyl ether (hereinafter, called DME). Other materials than dimethyl ether can be used as the coolant as long as they satisfy the requirements for it. For example, inorganic salts (sodium chloride, potassium chloride, etc.), bromine compounds (lithium bromide, bromo bromide, etc.), ethers (dimethyl ether, methyl ether, etc.), alcohols (methanol, ethanol, etc.), silicon oils, paraffinic hydrocarbon (propane, butane, etc.) , olefin-base hydrocarbon, and the like can be used as the coolant, which satisfy the requirements. In order to separate the toxic gas components liquefied or solidified from the coolant, the greater difference in boiling point between the coolant and the toxic gas components is more advantageous. From such a point of view, ethers and alcohols are preferred as the coolant.

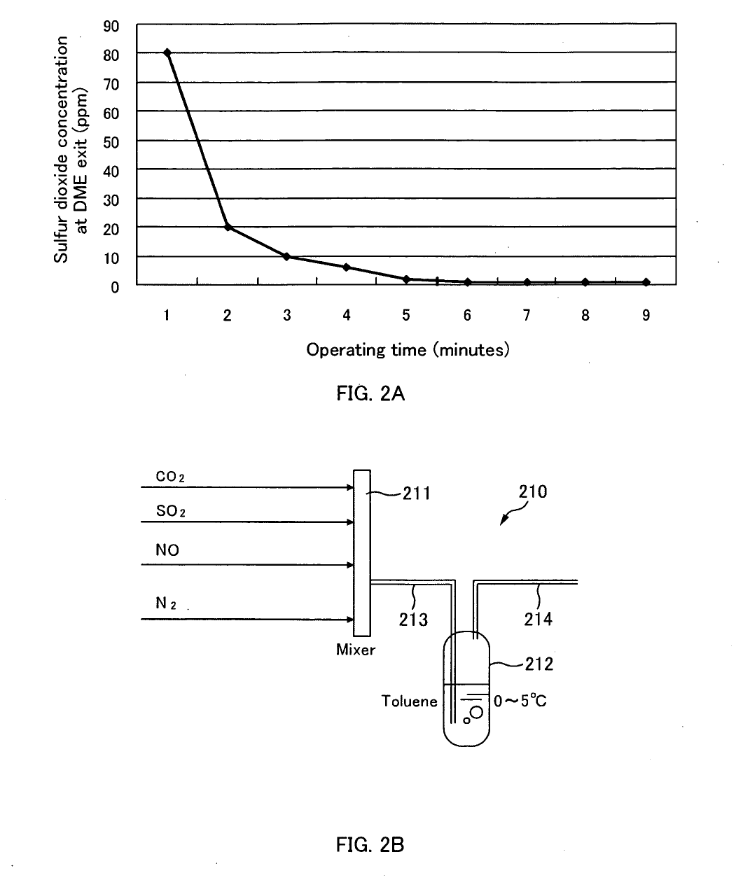

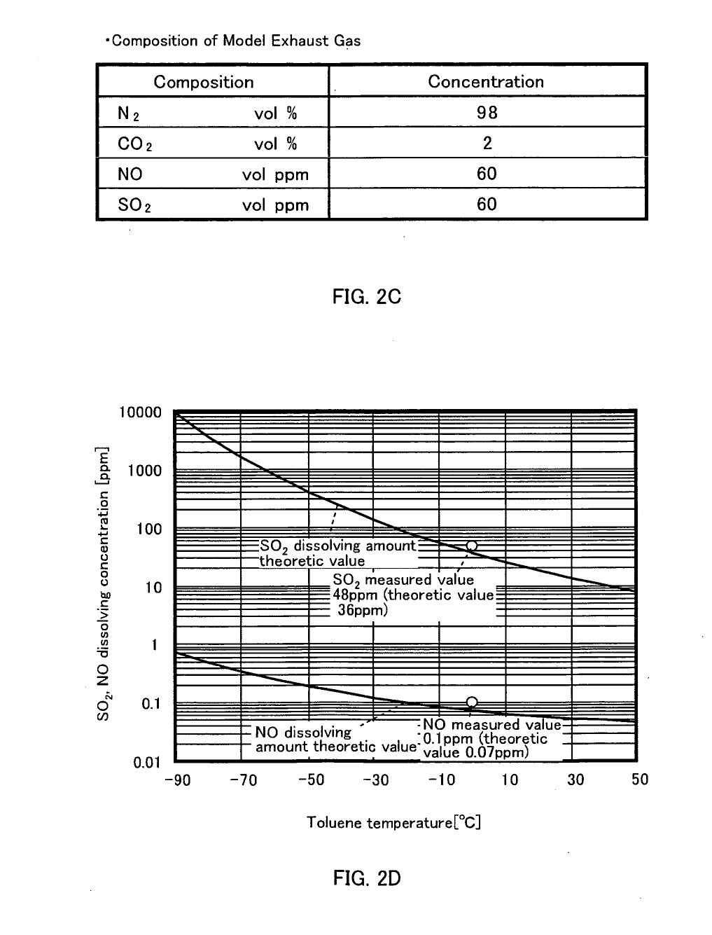

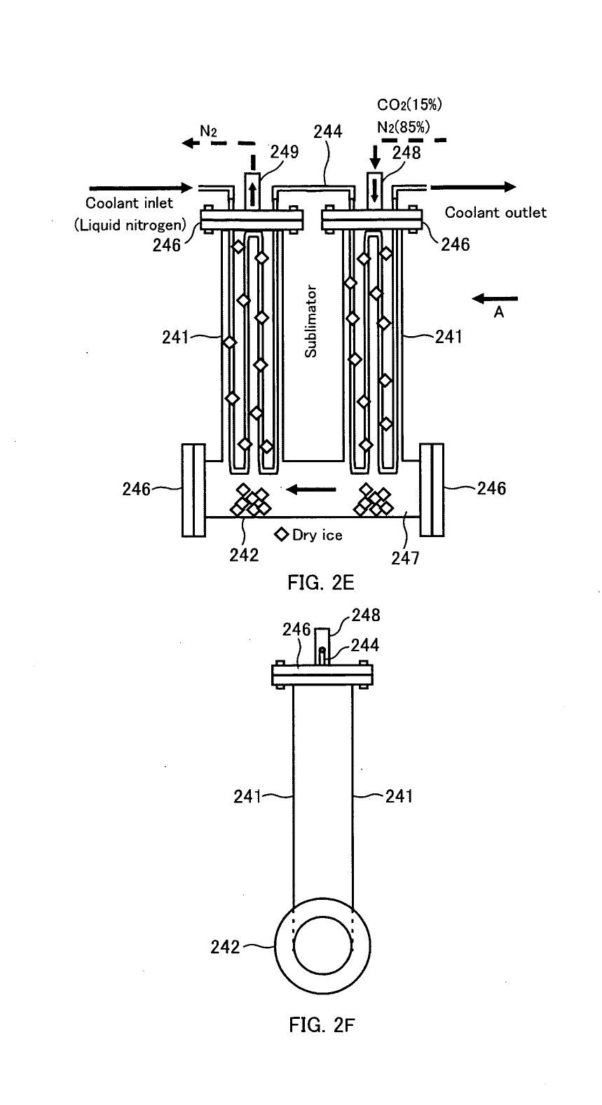

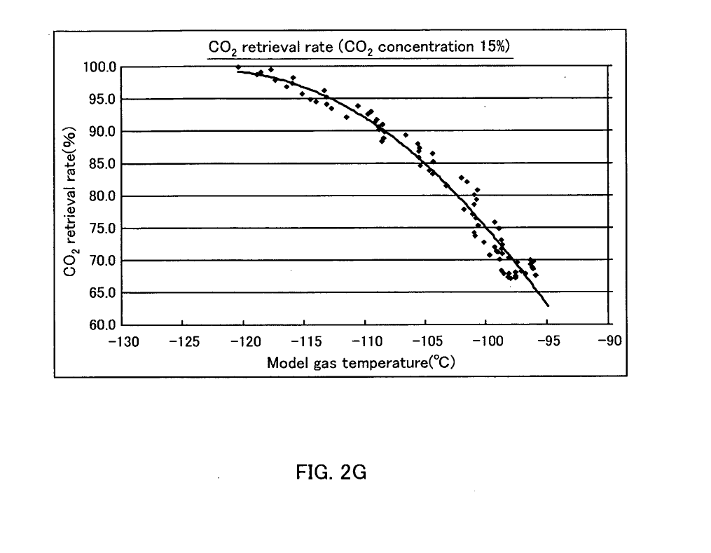

FIG. 2A shows results of measuring change in the concentration of carbon dioxide in the model gas when model gas having carbon dioxide in a concentration of 10% is made to flow through DME. As shown in the Figure, the concentration of carbon dioxide in the model gas decreases temporarily at the time when the model gas starts to flow through DME because the model gas dissolves in the DME, and thereafter, as time passes, gradually becomes closer to the concentration (10%) for before the circulation through DME. This is because after carbon dioxide in the DME is saturated, more carbon dioxide hardly dissolves in the DME. To confirm that the DME easily absorbs the toxic gas components such as nitrogen oxides, the inventors conducted an experiment of circulating model gas including the toxic gas components (nitrogen dioxide: 60 ppm, sulfur dioxide: 80 ppm, ammonia: 10 ppm) through DME. As a result, it was confirmed that all the toxic gas components in the model gas became 1 ppm or less in concentration in about an hour after the model gas starts to flow through DME.

Next, a specific scheme of the exhaust gas processing system of the present embodiment will be described in detail. First, in the preprocess, exhaust gas including toxic gas components such as nitrogen oxides, exhausted from the exhaust gas source 10 such as an LNG burning boiler is introduced into the heat exchanger 11, in which seawater (at, e.g., 25° C.) supplied via a seawater pump 12 and a coolant such as ethylene glycol circulated from a refrigerator 40 are introduced. The exhaust gas (at, e.g., 55° C.) introduced from the exhaust gas source 10 passes through the heat exchanger 11 and thereby is cooled by the seawater and the coolant to about room temperature.

The exhaust gas cooled to about room temperature in the heat exchanger 11 is then introduced into the condenser 13, and the exhaust gas introduced in the condenser 13 is introduced into industrial water contained in the condenser 13. Thereby, moisture, the toxic gas components, dust, and the like contained in the exhaust gas are removed. The liquefied water including the moisture, the toxic gas components, the dust, and the like removed from the exhaust gas is temporarily stored in an effluent cistern 14 and then introduced into an effluent processing apparatus 50 by an effluent pump 15. The exhaust gas having passed through the condenser 13 is then introduced by an exhaust gas fan 16 into the dehydrating tower 17. Note that heat exchange with the industrial water in the condenser 13 cools the exhaust gas from about room temperature to, e.g., 5° C.

In the dehydrating tower 17, the exhaust gas is further dehydrated and has the toxic gas components removed. By removing moisture contained in the exhaust gas, carbon dioxide contained in the exhaust gas can be retrieved efficiently later.

The exhaust gas is introduced into the dehydrating tower 17 at its lower end. The exhaust gas (at, e.g., 5° C.) introduced in the dehydrating tower 17 is made to flowthrough DME (at, e.g., −90° C.) as coolant for cooling the exhaust gas, with which the dehydrating tower 17 is filled, according to a bubbling method. The exhaust gas introduced in the dehydrating tower 17 is cooled through heat exchange with the DME to a cooling temperature, at which moisture and toxic gas components such as nitrogen oxides contained in the exhaust gas are liquefied or solidified while carbon dioxide is not solidified. By cooling the exhaust gas to such a temperature, the toxic gas components are liquefied or solidified and thus separated from the exhaust gas while carbon dioxide remains gas in the exhaust gas.

In order to confirm the function of the dehydrating tower 17 to remove the toxic gas components from the exhaust gas, the amounts of sulfur dioxide (SO₂) and nitrogen monoxide (NO) dissolving in the coolant were measured. FIG. 2B shows the configuration of an apparatus used in this measurement. As shown in the Figure, this apparatus 210 has a mixer 211 that produces a model exhaust gas, a cooling container 212 (e.g., a test tube or a beaker) for cooling the model exhaust gas that simulates the dehydrating tower 17, a gas introducing pipe 213 that introduces the model exhaust gas into the cooling container 212, and a gas exhausting pipe 214 for discharging gas accumulating above the cooling container 212 outside the cooling container 212, which are connected as shown in the Figure.

The cooling container 212 contains toluene (from 0 to 5° C., in an amount of 100 cc) as the coolant. The gas introducing pipe is set such that its opening is located below the liquid surface of the toluene. Furthermore, a mixture of carbon dioxide (CO₂) , sulfur dioxide (SO₂), nitrogen monoxide (NO) , and nitrogen (N₂) mixed by the mixer was used as the model exhaust gas. FIG. 2C shows the composition of the model exhaust gas. Measurement was made while the model exhaust gas was being introduced at a constant speed of 1 l/h.

FIG. 2D shows the measurement results. In the Figure, the measurement results are shown on a graph representing relationships between the temperature of the coolant (toluene) and the dissolving amounts (ppm) of sulfur dioxide (SO₂) and nitrogen monoxide (NO). The two curves drawn in the graph represent theoretical values calculated according to an SRK (Soave-Redlich-Kwong) respectively for the dissolving amounts (ppm) of sulfur dioxide (SO₂) and nitrogen monoxide (NO) . The circles marked on the graph indicate actual measured values obtained by the measurement, and the actual measured value of the dissolving amount of sulfur dioxide (SO₂) is 48 (ppm) and the actual measured value of the dissolving amount of nitrogen monoxide (NO) is 0.1 (ppm). Here, at the temperature corresponding to the marked circles, the theoretical value of the dissolving amount of sulfur dioxide (SO₂) is 36 (ppm) and the actual measured value of the dissolving amount of nitrogen monoxide (NO) is 0.07 (ppm). It is seen that either of the actual measured values almost coincides with its theoretical value.

From the above measurement, it was confirmed that the dissolving amounts of sulfur dioxide (SO₂) and nitrogen monoxide (NO) according to the temperature of the coolant can be theoretically obtained, and also that the toxic gas components can be separated efficiently from the exhaust gas in the dehydrating tower 17.

The DME is supplied circularly from a DME cooling tower 18 that cools the DME to the dehydrating tower 17. Through the DME cooling tower 18, coolant (liquid nitrogen) cooled by the refrigerator/heat exchanger 44 is circulated by a circulation pump 19. The DME is cooled through heat exchange with the coolant.

By making the exhaust gas flow through the dehydrating tower 17, moisture and the toxic gas components are liquefied or solidified and then introduced into a solid-liquid separation tower 22. The moisture and the toxic gas components are mixed with the DME. In this stage, substances into which moisture and the toxic gas components have solidified and the DME mixed therewith are in a sherbet state (slurry). The solid-liquid separation tower 22 separates the DME and the solidified substances of the moisture and toxic gas components. The DME separated by the solid-liquid separation tower 22 is introduced into a DME separation tower 20 to reuse the DME. The DME introduced into the DME separation tower 20 has some of moisture and the toxic gas components remaining.

The DME from the dehydrating tower 17 introduced in the DME separation tower 20 is raised in temperature (to, e.g., 5° C.) through indirect heat exchange with seawater. At this temperature, the moisture and the toxic gas components are liquid or solid, while the DME is gas. Hence, the DME gas rises to the upper portion of the DME separation tower 20, thereby being separated. The DME that has risen to the upper portion of the DME separation tower 20 is retrieved from there and introduced into the DME cooling tower 18, and again introduced into the dehydrating tower 17. In this way, the DME is reused circularly. As such, by reusing the DME as coolant circularly, the exhaust gas processing system of the embodiment as a whole is operated to use the coolant efficiently. Meanwhile, the liquid or solid moisture and toxic gas components that remain in the DME separation tower 20 are introduced into the effluent processing apparatus 50.

Exhaust gas including carbon dioxide that has risen to the upper portion of the dehydrating tower 17 is introduced into a reversible heat exchanger 23. The exhaust gas introduced in the reversible heat exchanger 23 is cooled through heat exchange with exhaust gas from a cyclone 25, described later, in the reversible heat exchanger 23, and then introduced into the dry ice sublimator 24. The exhaust gas introduced in the dry ice sublimator 24 is cooled through indirect heat exchange with coolant (liquid nitrogen) circulated through the dry ice sublimator 24 via the refrigerator/heat exchanger 40.

In order to confirm the retrieval rate of carbon dioxide (CO₂) in the dry ice sublimator 24, the retrieval rate of carbon dioxide (CO₂) against the temperature of model gas were measured. FIGS. 2E, 2F show the configuration of the dry ice sublimator 24 used in this measurement. FIG. 2E is a side view of the dry ice sublimator 24 and FIG. 2F is a side view of the dry ice sublimator 24 as seen in the direction indicated by an arrow A in FIG. 4E. As shown in the Figures, the dry ice sublimator 24 comprises two first cylinders 241 arranged upright (made of, e.g., SUS304) and a second cylinder 242 arranged in a horizontal position under the first cylinders 241 (that is, perpendicular to the first cylinders 241), which is in communication with the insides of the first cylinders 241. A coolant flow pipe 244 (material: copper; 900 mm in length, 20 turns, an outside area of 7.1 m²) through which coolant (e.g., liquid nitrogen) is circulated is placed inside the first cylinders 241. On the outside of the coolant flow pipe 244, screw-like fins (not shown) are formed to enlarge the contact area with carbon dioxide (CO₂) . The ends of the first cylinders 241 and the second cylinder 242 are each closed by a stopper 246.

A mixture of 15% of carbon dioxide (CO₂) and 85% of nitrogen (N₂) is used as the model gas. Measurement was made while the model gas was made to flow through by being introduced at flow speed of 670 l/minute through an inlet 248 made in one of the first cylinders 241 at a predetermined position and discharged from an outlet 249 made in the other first cylinder 241 at a predetermined position. By contacting the outside of the coolant flow pipe 244, the model gas introduced into the inside space 247 of the dry ice sublimator 24 is cooled to such a temperature that carbon dioxide (CO₂) solidifies while nitrogen (N₂) does not. Thus, the carbon dioxide in the model gas becomes dry ice, which deposits in the second cylinder 242. Also, the nitrogen component in the model gas is discharged from the outlet 249.

FIG. 2G shows the measurement results. In the Figure, a relationship between the temperature of the model gas discharged from the outlet 249 and the retrieval rate of carbon dioxide (CO₂) is indicated by a graph for when model gas containing carbon dioxide (CO₂) in a concentration of 15% is used. As the measurement results show, it was confirmed that carbon dioxide (CO₂) can be retrieved efficiently by the dry ice sublimator 24.

Dry ice generated in the dry ice sublimator 24 is introduced into the cyclone 25, which separates dry ice and exhaust gas. Of them, the exhaust gas is introduced into the reversible heat exchanger 23 and functions as coolant as mentioned previously. Because the exhaust gas cooled in the dry ice sublimator 24 functions as coolant in the reversible heat exchanger 23, energy consumption of the entire system for cooling is suppressed, thus realizing efficient processing. The exhaust gas used as coolant in the reversible heat exchanger 23 is introduced into the heat exchanger 11 and again used as coolant in the heat exchanger 11. Then, it is discharged through the smokestack 51 outside the system. To discharge the exhaust gas into the atmosphere is to discharge part of the exhaust gas outside the system to lessen the accumulation of the exhaust gas in the system. Therefore, carbon dioxide in the exhaust gas discharged into the atmosphere is very low in concentration.

Dry ice separated by the cyclone 25 is introduced into a dry ice melting device 26, which pressures and liquefies the dry ice. By liquefying dry ice, carbon dioxide is improved in storability and transferability, and becomes easy to handle. In order to liquefy efficiently dry ice produced in a large amount, a device using a screw-type push-out mechanism disclosed in Japanese Patent Application Laid-Open Publication No. 2000-317302, etc., or the like is used as the dry ice melting device 26. The liquefied carbon dioxide is stored in a liquefied-carbonic acid storage 27 and used as liquefied carbonic acid for various purposes.

Instead of the configuration including the dry ice sublimator 24, the cyclone 25, and the dry ice melting device 26 shown in FIG. 1, the configuration of the dry ice sublimator 24 of FIG. 2E can be adopted. In this case, three or more of the first cylinders 241 may be used, not being limited to two of them.

Here, the refrigerator/heat exchanger 44 cools ethylene glycol that is circulated through the heat exchanger 11 and coolant such as liquid nitrogen that is circulated through the DME cooling tower 18, the dry ice sublimator 24, etc., by use of the heat of vaporization of LNG 60. In, e.g., a generating station using LNG as gas fuel, the LNG is transported in a liquid state at a temperature of from −165° C. and stored in an LNG tank or the like. When the LNG is used as gas fuel, the LNG obtains the heat of vaporization from the atmosphere or seawater to rise in temperature and vaporize, while the refrigerator/heat exchanger 44 cools coolants such as ethylene glycol and liquid nitrogen by using this heat of vaporization. That is, exhaust gas or coolant is cooled by using the heat of vaporization that is produced when the LNG is used as gas fuel. Technology of solidifying and separating carbon dioxide contained in exhaust gas by using the heat of vaporization of LNG is disclosed in, e.g., Japanese Patent Application Laid-Open Publication No. H08-12314 or the like.

As described above, the exhaust gas processing system of the present embodiment can efficiently remove moisture and toxic gas components from exhaust gas including the toxic gas components such as nitrogen oxides, exhausted from an LNG burning boiler or the like, and further, can efficiently retrieve carbon dioxide from the exhaust gas while removing moisture and toxic gas components efficiently.

Here, toxic gases to be removed from exhaust gas include, for example, carbon monoxide, nitrogen oxides (NOx) such as nitrogen monoxide, and halogen compounds such as hydrogen fluoride. By setting the solidifying temperature of carbon dioxide and the liquefying or solidifying temperature of the toxic gas components appropriately and selecting an appropriate one as the coolant, the toxic gas components can be removed efficiently.

That is, an exhaust gas processing system can be realized wherein by making exhaust gas that includes another type of toxic gas flow through coolant to cool it to a first temperature, the toxic gas contained in the exhaust gas is liquefied or solidified and separated from the exhaust gas, and wherein by cooling the exhaust gas to a second temperature lower than the first temperature, carbon dioxide contained in the exhaust gas is solidified and separated from the exhaust gas.

The above description is provided to facilitate the understanding of the present invention and not intended to limit the present invention. It should be understood that various changes and alterations can be made therein without departing from the spirit and scope of the invention and that the present invention includes it's equivalents.

What is claimed is:

1. A method of removing moisture and toxic gas components from exhaust gas, characterized by comprising:
a process of making exhaust gas, exhausted from an LNG burning boiler, flow through coolant contained in a dehydrating tower to cool it to such a temperature as to solidify moisture and nitrogen oxides but not carbon dioxide, thereby solidifying moisture and nitrogen oxides contained in the exhaust gas to separate from the exhaust gas;
a process of introducing the solidified moisture and nitrogen oxides into a solid-liquid separator thereby separating the moisture or the nitrogen oxides from the coolant; and
a process of making the coolant be contained in a cooling tower so as to be cooled, and then making the coolant be contained in the dehydrating tower again so as to be circulated.

2. The method of removing moisture and toxic gas components from exhaust gas according to claim 1, characterized by comprising:
a process of introducing the moisture and nitrogen oxides separated from the coolant into a separation tower and raising in temperature the moisture and nitrogen oxides thereby liquefying the moisture and nitrogen oxides.

3. The method of removing moisture and toxic gas components from exhaust gas according to claim 2, characterized by comprising:
a process of introducing the coolant retrieved in the separation tower into the cooling tower.

4. The method of removing moisture and toxic gas components from exhaust gas according to any one of claims 1 to 3, characterized in that the coolant includes any one of dimethyl ether, methanol, ethanol, toluene, and ethyl benzene.

5. The method of removing moisture and toxic gas components from exhaust gas according to any one of claims 1 to 4, characterized by comprising:
a process of cooling the coolant by using the heat of vaporization that is produced when LNG is used as gas fuel.

6. A system of removing moisture and toxic gas components from exhaust gas, characterized by comprising:
an apparatus of making exhaust gas, exhausted from an LNG burning boiler, flow through coolant contained in a dehydrating tower to cool it to such a temperature as to solidify moisture and nitrogen oxides but not carbon dioxide, thereby solidifying moisture and nitrogen oxides contained in the exhaust gas to separate from the exhaust gas;
an apparatus of introducing the solidified moisture and nitrogen oxides into a solid-liquid separator thereby separating the moisture or the nitrogen oxides from the coolant; and
an apparatus of making the coolant be contained in a cooling tower so as to be cooled, and then making the coolant be contained in the dehydrating tower again so as to be circulated.

7. The system of removing moisture and toxic gas components from exhaust gas according to claim 6, characterized by comprising:
an apparatus of introducing the moisture and nitrogen oxides separated from the coolant into a separation tower and raising in temperature thereby liquefying the moisture and nitrogen oxides.

8. The system of removing moisture and toxic gas components from exhaust gas according to claim 7, characterized by comprising:
an apparatus of introducing the coolant retrieved in the separation tower into the cooling tower.

9. The system of removing moisture and toxic gas components from exhaust gas according to any one of claims 6 to 8, characterized in that the coolant includes any one of dimethyl ether, methanol, ethanol, toluene, and ethyl benzene.

10. The system of removing moisture and toxic gas components from exhaust gas according to any one of claims 6 to 9, characterized by comprising:
an apparatus of cooling the coolant by using the heat of vaporization that is produced when LNG is used as gas fuel.
